(19) United States
(12) Patent Application Publication
(10) Pub. No.: US 2025/0051596 A1
(43) Pub. Date: Feb. 13, 2025

(54) INK JET RECORDING METHOD AND INK JET RECORDING APPARATUS

(71) Applicant: CANON KABUSHIKI KAISHA, Tokyo (JP)

(72) Inventors: ATSUHITO YOSHIZAWA, Tokyo (JP); SOICHI NAGAI, Kanagawa (JP); YUKO NISHIWAKI, Tokyo (JP); ERIKO YOSHINO, Kanagawa (JP)

(21) Appl. No.: 18/796,693

(22) Filed: Aug. 7, 2024

(30) Foreign Application Priority Data
Aug. 7, 2023 (JP) 2023-128303
Jul. 23, 2024 (JP) 2024-117458

(51) Int. Cl. C09D 11/322; B41J 2/175; B41J 2/21

(52) U.S. Cl. CPC C09D 11/322; B41J 2/17513; B41J 2/17523; B41J 2/2107

(57) ABSTRACT

Provided is an ink jet recording method using a downsized recording apparatus having mounted thereon a recording unit in a form in which a recording head is incorporated into an ink storage portion, and providing an excellent sticking recovery property while maintaining a strength of the recording unit even when an aqueous ink containing a pigment is used. The ink jet recording method includes recording an image through use of an ink jet recording apparatus including: an aqueous ink; an ink storage portion; and a recording head. The ink storage portion includes three or more storage parts divided and arrayed in one predetermined direction. A specific gravity of a pigment in the aqueous ink stored in the storage part arranged on an inner side is larger than a specific gravity of a pigment in the aqueous ink stored in each of the storage parts arranged at both end portions.

### BACKGROUND OF THE INVENTION

### Field of the Invention

The present invention relates to an ink jet recording method and an ink jet recording apparatus.

### Description of the Related Art

In recent years, there is an increasing demand for an ink jet recording apparatus for household use due to an increase of remote work at home and the like. Further, for household use, the ink jet recording apparatus is desired to be further downsized. For downsizing of the ink jet recording apparatus, downsizing of a recording head and an ink storage portion is essential. For example, there is known an ink jet recording apparatus having mounted thereon a recording unit downsized by integrating the ink storage portion and the recording head with each other.

Some of those ink jet recording apparatus adopt a recording head employing a system of ejecting ink by an action of thermal energy from the viewpoint that the ink jet recording apparatus can be designed to be more downsized. Further, the recording head has been devised to be downsized by providing ejection orifice arrays for ejecting respective inks of a plurality of colors in the same recording element substrate. Moreover, some recording units are downsized by bonding the recording head to the ink storage portion without intermediation of any other member. In addition, the apparatus is downsized by forming the ink storage portion from a thermoplastic resin to reduce the weight of the recording unit, and decreasing the rigidity required for a carriage portion.

However, the ink storage portion formed from only a thermoplastic resin has problems of being liable to be deformed and being liable to crack due to an external pressure such as an impact applied by falling. In order to solve such problems, there has been proposed an ink storage container formed from a material obtained by adding a filler material such as a glass filler to a thermoplastic resin so that a linear expansion coefficient is reduced (Japanese Patent Application Laid-Open No. 2008-142935).

In a case of an ink jet recording apparatus assumed to output also documents for use in business such as remote work at home, there is a demand for a high level of permanence even for a color image, and hence a pigment ink using a pigment as a coloring material is suitably used. In addition, from the viewpoint of color developability of the image, a phthalocyanine pigment, a quinacridone pigment and an azo pigment are widely used as a pigment for a cyan ink, a pigment for a magenta ink and a pigment for a yellow ink, respectively. When an ink containing a pigment as a coloring material is left without being ejected for a long period, the ink may stick at the ejection orifice of the recording head to cause difficulty in ejection. Accordingly, there is widely used an ink jet recording apparatus including a unit for capping and sucking the ejection orifice to recover the ejection orifice from the sticking state.

The inventors of the present invention have verified the ink storage portion formed from a thermoplastic resin composition containing a filler material, which has been proposed in Japanese Patent Application Laid-Open No. 2008-142935. Specifically, a recording unit formed by bonding a recording head to this ink storage portion (hereinafter also simply referred to as “recording unit”) was prepared. Then, cyan, magenta and yellow pigment inks were stored in respective divided storage parts in an ink storage container (ink storage portion) having a structure disclosed in Japanese Patent Application Laid-Open No. 2008-142935, and the ink storage container was left for 3 months under an environment at a temperature of 35° C. and a relative humidity of 20%. Then, after the leaving, an image was recorded without carrying out a sucking operation. As a result, all of the inks stuck in the vicinities of the ejection orifices to cause non-ejection. When the sucking operation was carried out, the inks of the respective colors had a difference in the number of sucking operations required until the non-ejection was solved, and hence it was found that the sticking recovery property needed to be improved.

### SUMMARY OF THE INVENTION

Thus, the present invention has an object to solve problems caused when a recording apparatus having mounted thereon a recording unit in a form in which a recording head is incorporated into an ink storage portion formed from a thermoplastic resin composition containing a filler material is used and an aqueous ink containing a pigment is used. That is, the present invention has an object to provide an ink jet recording method providing an excellent sticking recovery property of an aqueous ink containing a pigment while maintaining a strength of a recording unit even when such a downsized recording apparatus is used. Further, the present invention has another object to provide an ink jet recording apparatus to be used in this ink jet recording method.

That is, according to the present invention, there is provided an ink jet recording method using an ink jet recording apparatus, the ink jet recording apparatus including: an aqueous ink containing a pigment; an ink storage portion which is configured to store the aqueous ink, and is formed from a thermoplastic resin composition containing a filler material; and a recording head to be bonded to the ink storage portion, the recording head having formed therein an ejection orifice configured to eject the aqueous ink supplied from the ink storage portion, the ink jet recording method further comprising recording an image by applying the aqueous ink ejected from the ejection orifice to a recording medium. The ink storage portion includes three or more storage parts divided independently of each other, and the three or more storage parts are arrayed in one predetermined direction. A specific gravity of the pigment in the aqueous ink stored in a corresponding one of the three or more storage parts arranged on an inner side is larger than a specific gravity of the pigment in the aqueous ink stored in each of corresponding two of the three or more storage parts arranged at both end portions.

According to the present invention, it is possible to solve problems caused when the recording apparatus having mounted thereon the recording unit in a form in which the recording head is incorporated into the ink storage portion formed from the thermoplastic resin composition containing the filler material is used and the aqueous ink containing the pigment is used. That is, it is possible to provide the ink jet recording method providing an excellent sticking recovery property of the aqueous ink containing the pigment while maintaining a strength of the recording unit even when such a downsized recording apparatus is used. Further, according to the present invention, it is possible to provide the ink jet recording apparatus to be used in this ink jet recording method.

Further features of the present invention will become apparent from the following description of exemplary embodiments with reference to the attached drawings.

### BRIEF DESCRIPTION OF THE DRAWINGS

FIG. 1 is a perspective view for schematically illustrating an ink jet recording apparatus according to one embodiment of the present invention.

FIG. 2 is a perspective view for schematically illustrating an internal structure of the ink jet recording apparatus according to one embodiment of the present invention.

FIG. 3 is a view for schematically illustrating an example of a recording unit. (a) is a perspective view, and (b) is a perspective view of an exploded state.

FIG. 4 is a view for schematically illustrating an example of the recording unit. (a) is a view as viewed from above with a tank lid being removed, and (b) is a view as viewed from below.

FIG. 5 is a view for schematically illustrating another example of the recording unit. (a) is a view as viewed from above with the tank lid being removed, and (b) is a view as viewed from below.

FIG. 6 is a schematic view for illustrating an example of a sucking unit.

FIG. 7A is a schematic view for illustrating an example of an array mode of storage parts.

FIG. 7B is a schematic view for illustrating another example of the array mode of the storage parts.

FIG. 7C is a schematic view for illustrating another example of the array mode of the storage parts.

FIG. 7D is a schematic view for illustrating another example of the array mode of the storage parts.

FIG. 7E is a schematic view for illustrating another example of the array mode of the storage parts.

### DESCRIPTION OF THE EMBODIMENTS

The present invention is described in more detail below by way of exemplary embodiments. In the present invention, when a compound is a salt, the salt is present as dissociated ions in an ink, but the expression “contain a salt” is used for convenience. In addition, an aqueous ink for ink jet is sometimes simply referred to as “ink”. Physical property values are values at normal temperature (25° C.) unless otherwise stated.

The inventors of the present invention have verified causes of reduction of the sticking recovery property in a case of using an ink jet recording apparatus having mounted thereon a recording unit in a form in which a recording head is incorporated into an ink storage portion formed from a thermoplastic resin composition containing a filler material. Specifically, the inventors of the present invention have verified reasons why inks of respective colors have a difference in the number of sucking operations required until non-ejection is solved and the sticking recovery property is reduced.

The recording unit in the form in which the recording head is incorporated into the ink storage portion formed from the thermoplastic resin composition containing the filler material is normally stored under a state in which the ink storage portion is filled with the ink, and the recording unit is set to the ink jet recording apparatus at the time of starting usage of the apparatus. As a result of the verification, it was found that an inorganic metal, such as calcium (Ca), magnesium (Mg), iron (Fe) and aluminum (Al), was liable to be eluted from the filler material during storage to be dissolved into the ink. Further, when a pigment ink containing a resin is used, pH of the ink is sometimes set to be high in order to suppress precipitation of the resin. However, it was found that the inorganic metal was more liable to be dissolved in the ink for which pH is set to be high. It is considered that, when the inorganic metal is dissolved in the ink, a dispersion state of the pigment is liable to become unstable and thus the sticking recovery property is reduced.

Further, it cannot be said that a gas barrier property of the ink storage portion formed from the thermoplastic resin composition containing the filler material is always high. Accordingly, the following can also be considered as causes of reduction of the sticking recovery property. That is, a liquid component such as water in the ink stored in the ink storage portion gradually evaporates so that the concentration of the pigment in the ink relatively increases. Thus, the dispersion state of the pigment becomes unstable, or the sedimentation of the pigment may be promoted.

Moreover, the inventors of the present invention produced an ink storage portion which included three or more storage parts divided independently of each other and in which those storage parts were arrayed in one predetermined direction. In addition, a cyan ink, a magenta ink and a yellow ink were stored in the respective storage parts arrayed in one row, and the ink storage portion was left for 3 months under an environment at a temperature of 35° C. and a relative humidity of 20%, which are conditions that easily cause evaporation of the ink. After that, the sucking operation was performed to carry out a sticking recovery test for achieving recovery from the sticking of the ink. As a result, it was found that the number of sucking operations required until recovery from the sticking was achieved varied depending on the ink. Specifically, it was found that, as compared to the magenta ink and the yellow ink, the cyan ink required a larger number of sucking operations until recovery from sticking. A specific gravity of a copper phthalocyanine pigment used as a pigment of the cyan ink is larger than any of specific gravities of a quinacridone pigment and an azo pigment used as pigments of the magenta ink and a specific gravity of an azo pigment used as a pigment of the yellow ink. In addition, a pigment having a relatively large specific gravity is liable to be settled, and thus the cyan ink is liable to stick. It is considered that the sticking recovery property is reduced as described above.

Next, the inventors of the present invention produced an ink storage portion which included three or more storage parts divided independently of each other and in which those storage parts were arrayed in one predetermined direction. Then, the inventors of the present invention have found that, when the specific gravity of the pigment in the aqueous ink stored in the storage part arranged on the inner side was set to be larger than the specific gravity of the pigment in the aqueous ink stored in each of the storage parts arranged at both end portions, the sticking recovery property was able to be improved. Thus, the present invention has been made. When three or more storage parts are arrayed in one direction, water moves from each of the storage parts arranged on both sides to the storage part arranged on the inner side, and the content of water in the ink stored in the storage part arranged on the inner side is slightly increased (is humidified). Further, the storage part arranged on the inner side has a relatively small contact area with external air, and hence the water in the stored ink is less liable to evaporate as compared to the storage parts arranged on both sides. In addition, when an ink containing a pigment having a relatively large specific gravity and being settled more easily is stored in the storage part arranged on the inner side, sticking of the cyan ink that is liable to stick by sedimentation can be reduced. As a result, the difference in sticking recovery property between the inks can be reduced, and the number of sucking operations required for the recovery from the sticking can be reduced. Thus, the sticking recovery property can be improved.

### <Ink Jet Recording Method and Ink Jet Recording Apparatus>

The ink jet recording method of the present invention is a recording method using an ink jet recording apparatus including an ink containing a pigment, an ink storage portion for storing the ink, and a recording head bonded to the ink storage portion. The ink storage portion is formed from a thermoplastic resin composition containing a filler material. In the recording head, an ejection orifice for ejecting the ink supplied from the ink storage portion is formed. In addition, the ink jet recording method of the present invention includes a step of recording an image by applying the ink ejected from the ejection orifice to a recording medium. The ink storage portion includes three or more storage parts divided independently of each other, and those storage parts are arrayed in one predetermined direction. In addition, a specific gravity of the pigment in the ink stored in a corresponding one of the storage parts arranged on an inner side is larger than a specific gravity of the pigment in the ink stored in corresponding two of the storage parts arranged at both end portions.

Further, the ink jet recording apparatus of the present invention is an ink jet recording apparatus including an ink containing a pigment, an ink storage portion for storing the ink, and a recording head bonded to the ink storage portion. The ink storage portion is formed from a thermoplastic resin composition containing a filler material. In the recording head, an ejection orifice for ejecting the ink supplied from the ink storage portion is formed. The ink storage portion includes three or more storage parts divided independently of each other, and those storage parts are arrayed in one predetermined direction. In addition, a specific gravity of the pigment in the ink stored in a corresponding one of the storage parts arranged on an inner side is larger than a specific gravity of the pigment in the ink stored in corresponding two of the storage parts arranged at both end portions.

### (Ink Jet Recording Apparatus)

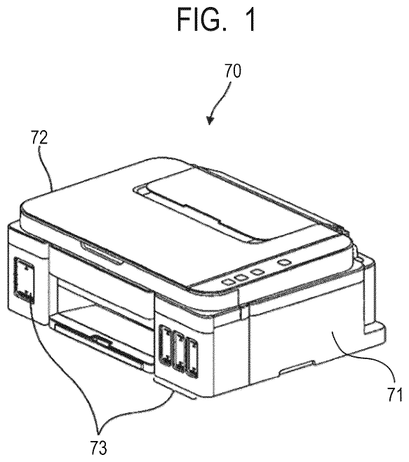

FIG. 1 is a perspective view for schematically illustrating an ink jet recording apparatus according to one embodiment of the present invention. As illustrated in FIG. 1, an ink jet recording apparatus 70 of this embodiment includes an outer package 71 and a cover member 72 arranged on the upper surface of the outer package 71. The cover member 72 is a member that is openable and closable in a vertical direction, and its opening in an upper direction enables the observation of the inside of the ink jet recording apparatus 70 having a rectangular parallelepiped shape.

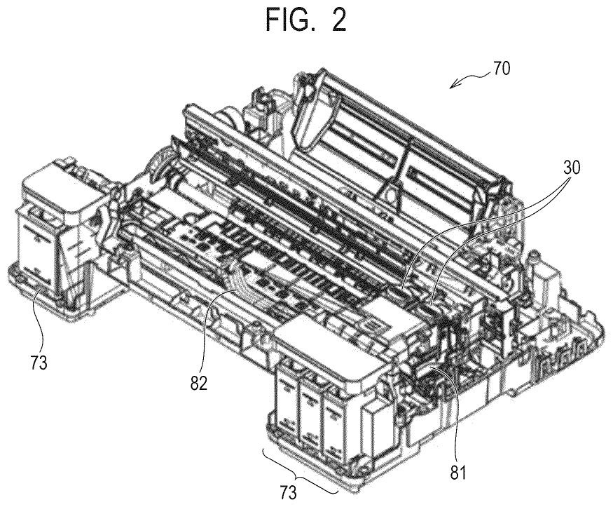

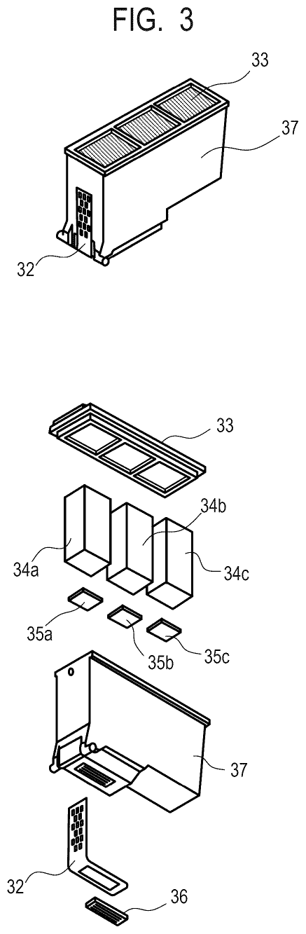

FIG. 2 is a perspective view for schematically illustrating the internal structure of the ink jet recording apparatus according to one embodiment of the present invention. A recording unit 30 in which a recording head and an ink storage portion are integrally formed is configured to be mountable to a carriage (support member) 81. The recording unit 30 is provided on the carriage by being coupled to a joint (not shown) provided at an upper portion of the carriage 81. The recording unit 30 is coupled to a tube 82 which is a flexible member, and another end of the tube 82 is coupled to a main tank (second ink storage portion) 73 which is a second ink storage portion. When the recording unit 30 is mounted to the carriage 81, a recording head 36 ((b) in FIG. 3) is allowed to communicate with the main tank 73 via the joint and the tube 82. The ink jet recording apparatus 70 of this embodiment is a recording apparatus of a serial scan type, and the carriage 81 is guided to be movable in a main scanning direction by a guide shaft. The carriage 81 reciprocates in the main scanning direction by a carriage motor and a drive force transmission mechanism such as a belt for transmitting a drive force of the carriage motor (both not shown).

A recording medium is conveyed by a conveyance roller in a sub-scanning direction orthogonal to the main scanning direction of the carriage 81. The ink jet recording apparatus 70 repeatedly performs a recording operation of ejecting an ink toward a recording region of the recording medium on a platen while moving the recording head 36 ((b) in FIG. 3) in the main scanning direction, and a conveying operation of conveying the recording medium in the sub-scanning direction by a distance corresponding to its recording width. In this manner, an image is sequentially recorded on the recording medium.

FIG. 3 is a view for schematically illustrating an example of the recording unit. (a) is a perspective view, and (b) is a perspective view of an exploded state. The recording unit illustrated in FIG. 3 includes an ink storage portion 37 and the recording head 36. The ink storage portion 37 is a casing formed from a thermoplastic resin composition containing a filler material. Examples of the thermoplastic resin composition include polyester, polycarbonate, polypropylene, polyethylene, polystyrene, polyphenylene ether and mixtures or modified substances of them. Examples of the filler material include a flake filler such as mica and a fibrous filler such as a glass fiber. A general glass fiber is a glass fiber (chopped strand) made of a material called E-glass (non-alkali glass) in a form of being cut into a predetermined length. The recording head 36 is preferably bonded to the ink storage portion 37 without through intermediation of any other member. The ink storage portion 37 has a light weight because the portion is a casing formed from a thermoplastic resin composition. The entirety of the recording unit is reduced in size and weight because the recording head 36 is bonded to the ink storage portion 37 without through intermediation of any other member such as a heat-radiating plate. The use of such recording unit can reduce the size and weight of the entirety of the ink jet recording apparatus. The heat-radiating plate may be, for example, a plate formed from a material such as a metal oxide such as alumina. Further, the ink storage portion 37 formed from the thermoplastic resin composition containing the filler material has a linear expansion coefficient lower than that of a member formed from a thermoplastic resin containing no filler material. Accordingly, deformation of the casing can be suppressed, and occurrence of cracking due to an external pressure such as falling can be suppressed.

The recording head 36 has arranged therein, for example, a plurality of ejection orifices that ejects the ink and an energy-generating element that generates energy for ejecting the ink. The energy-generating element and the like may be driven by, for example, electric power supplied through an electrical wiring member 32. The energy-generating element is an element that generates thermal energy or mechanical energy, and the action of the generated energy can eject the ink from the ejection orifices. Examples of the element that generates thermal energy include an electrothermal converter. Examples of the element that generates mechanical energy include a piezoelectric element. Of those, a recording head that ejects the ink by the action of the thermal energy is preferable because the recording head can be designed to be downsized.

The recording head 36 includes an ejection orifice surface in which a plurality of ejection orifice arrays each formed of a plurality of ejection orifices is arrayed in the same recording element substrate. When the plurality of ejection orifice arrays is arrayed in the same recording element substrate, a plurality of inks can be ejected by one recording unit, and thus the ink jet recording apparatus can be downsized. The plurality of ejection orifice arrays is preferably arrayed in a direction (sub-scanning direction) orthogonal to a reciprocating direction (main scanning direction) of the recording unit into which the recording head is incorporated. Further, with the ejection orifice array being formed of the plurality of ejection orifices, a recordable region at the time of reciprocating the recording head can be enlarged, and hence fast recording can be performed.

Sponge-like ink absorbers 34a to 34c are stored in the ink storage portion 37. In addition, filters 35a to 35c are arranged below the ink storage portion 37 in a gravity direction. When a negative pressure is generated by utilizing the capillary forces of the sponge-like ink absorbers 34a to 34c, the ink can be prevented from leaking from the ejection orifices. In addition, the arrangement of the filters 35a to 35c can suppress the entry of fine foreign matter such as dirt into the ejection orifices. Further, provision of a tank lid 33 by thermocompression bonding on an upper side of the ink storage portion 37 in the gravity direction can prevent the ink from leaking from the ink storage portion 37.

The recording head preferably includes a warming unit for warming the ink in the recording head. The warming unit only needs to be a unit that can warm the ink in the recording head to a temperature higher than a recording environment temperature such as a room temperature (25° C.). Examples of such warming unit may include: a heater for ink temperature control arranged so as to be brought into contact with the recording head; and a heater for ink ejection. To warm the ink with the heater for ink ejection, for example, such a current that the ink is not ejected can be repeatedly passed through the heater.

The ink jet recording apparatus further preferably includes a second ink storage portion and a tube. The second ink storage portion such as a main tank has a capacity larger than that of the ink storage portion (first ink storage portion) such as a sub tank. The tube allows the ink to flow between the second ink storage portion and the ink storage portion. In consideration of a usage mode or the like in remote work at home, reduction in replacement frequency of an ink cartridge is also important in addition to downsizing of the apparatus. Accordingly, further provision of the second ink storage portion such as the main tank can reduce the ink replacement frequency while the increase in size of the apparatus main body is avoided. In the following, an ink jet recording apparatus in which only the first ink storage portion such as the sub tank bonded to the recording head is provided as the ink storage portion is also referred to as “first apparatus configuration.” In the case of the first apparatus configuration, when the ink stored inside of the ink storage portion has been consumed, the ink storage portion is replaced with another ink storage portion (ink storage portion filled with an ink). Thus, as compared to a second apparatus configuration, the main tank and the tube can be omitted, and thus the weight of the ink jet recording apparatus can be reduced. Further, an ink jet recording apparatus in which the second ink storage portion such as the main tank having a capacity larger than that of the sub tank is further provided as the ink storage portion is also referred to as “second apparatus configuration.” In the case of the second apparatus configuration, for example, when a connection portion for a tube is formed in the tank lid 33 illustrated in FIG. 3, the ink storage portion 37 and the second ink storage portion such as the main tank can be connected to each other.

In the case of the second apparatus configuration, the ink replacement frequency is reduced as compared to the first apparatus configuration, and hence a period in which an ink in a stationary state is kept in the main tank becomes long. Further, in a case of a pigment ink, when the period in which the ink is kept in the stationary state becomes long, the pigment is liable to be settled. Degradation of an ejection property caused by sticking occurs because the ink dries in the flow path and the pigment aggregates. Thus, the degradation of the ejection property becomes more remarkable as an ink having a larger content of the pigment is used. In addition, depending on the usage state, the sticking recovery property of the second apparatus configuration is often lower than the sticking recovery property of the first apparatus configuration. In particular, sticking caused by sedimentation is more remarkable in an ink having a larger specific gravity of the pigment. Meanwhile, in the ink jet recording method of the present invention, the sticking of an ink having a large specific gravity of a pigment can be reduced, and hence both of the reduction in ink replacement frequency and the improvement in sticking recovery property can be achieved.

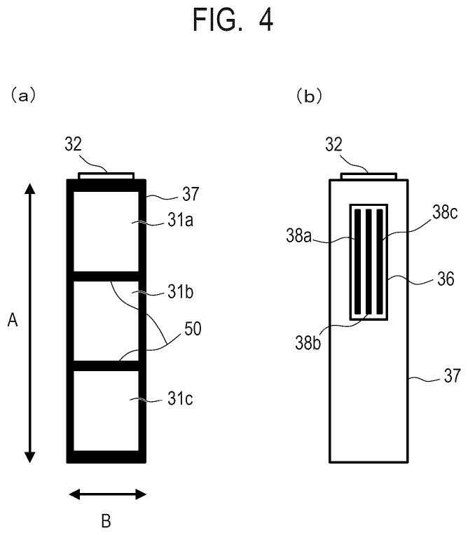

FIG. 4 is a view for schematically illustrating an example of the recording unit. (a) is a view as viewed from above with the tank lid being removed, and (b) is a view as viewed from below (recording head side). As illustrated in FIG. 4, the ink storage portion 37 includes three or more storage parts 31a to 31c divided independently of each other. Those storage parts 31a to 31c are divided by, for example, partition portions 50 formed from the same material as the casing, and are capable of individually storing a plurality of kinds of inks. Further, the recording head 36 includes an ejection orifice surface in which a plurality of ejection orifice arrays 38a to 38c each formed of a plurality of ejection orifices is arrayed in the same recording element substrate. Those ejection orifice arrays 38a to 38c correspond to the plurality of kinds of inks individually stored in the storage parts 31a to 31c, respectively, and are arrayed in one predetermined direction. In addition, a specific gravity of the pigment in the ink stored in the storage part 31b arranged on the inner side is larger than a specific gravity of the pigment in the ink stored in each of the storage parts 31a and 31c arranged at both end portions. The storage part 31b arranged on the inner side has a relatively small contact area with the external air, and hence water is less liable to evaporate from the stored ink as compared to the storage parts 31a and 31c arranged on both sides. Further, water moves from each of the storage parts 31a and 31c arranged on both sides to the storage part 31b arranged on the inner side, and hence the content of water in the ink stored in the storage part 31b is slightly increased (is humidified). Thus, it is considered that the sticking recovery property can be improved by reducing sticking of an ink containing a pigment having a relatively large specific gravity, which is stored in the storage part 31b.

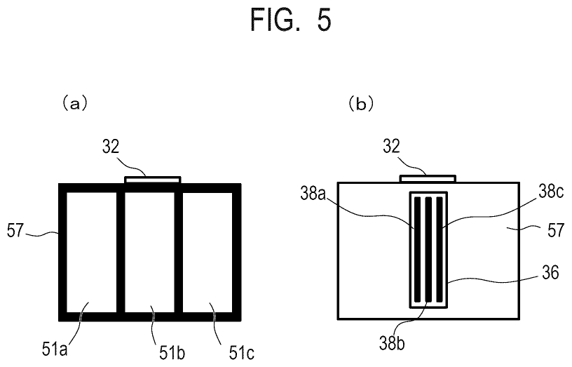

FIG. 5 is a view for schematically illustrating another example of the recording unit. (a) is a view as viewed from above with the tank lid being removed, and (b) is a view as viewed from below (recording head side). An ink storage portion 57 illustrated in FIG. 5 includes three or more storage parts 51a to 51c divided independently of each other, and those storage parts 51a to 51c are arrayed in one predetermined direction. An array direction of the plurality of storage parts only needs to be one direction in a predetermined direction. For example, the storage parts may be arrayed in a direction orthogonal to the main scanning direction of the recording head 36 as illustrated in FIG. 4, or may be arrayed in a direction parallel to the main scanning direction of the recording head 36 as illustrated in FIG. 5. From the viewpoint of the strength of the ink storage portion, the array direction of the plurality of storage parts is particularly preferably the array direction orthogonal to the main scanning direction of the recording head 36.

In the ink storage portion, a ratio (A/B) of a length A in a longitudinal direction (sub-scanning direction) to a length B in a transverse direction (main scanning direction) is preferably 2.0 times or more to 4.0 times or less ((a) in FIG. 4). When the ratio A/B is set to 2.0 times or more, a compact apparatus width can be achieved. In order to record an image on the entire surface of the recording medium through use of a so-called serial type ink jet recording apparatus in which the image is recorded while the recording head scans back and forth in the main scanning direction orthogonal to the conveying direction of the recording medium, it is required to move the ejection orifice array from one end to another end of the recording medium. When the width of the recording head is wide, the width of the ink jet recording apparatus becomes inevitably wide. Further, in a case in which the ratio A/B of the ink storage portion is excessively large, when an external force is applied to the casing, the stress concentrates in the longitudinal direction, and, in some cases, deformation due to the insufficient strength of the casing may occur. Accordingly, the ratio A/B is preferably 4.0 times or less.

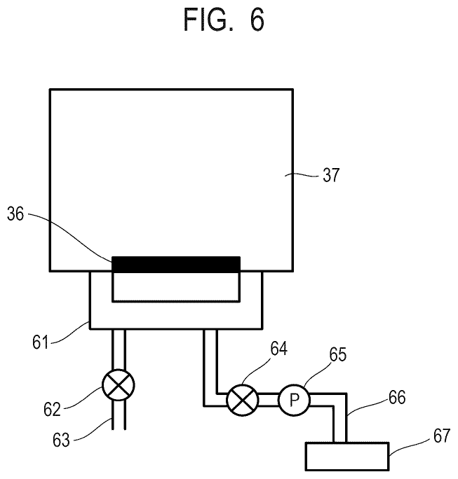

FIG. 6 is a schematic view for illustrating an example of a sucking unit. As illustrated in FIG. 6, the ink jet recording apparatus includes a cap 61 for covering the plurality of ejection orifice arrays in abutment against a region including the ejection orifice surface of the recording head 36. A tube 63 and a waste ink tube 66 are connected to the cap 61. The tube 63 functions as an atmosphere communicating portion, and the waste ink tube 66 discharges a waste ink not used for recording, which is accumulated in the cap 61. In the middle of the tube 63, an atmosphere communicating valve 62 is provided. The waste ink discharged from the ejection orifice of the recording head 36 is stored in a waste ink storage portion 67. A suction valve 64 is provided in the middle of the waste ink tube 66, and a sucking operation for discharging the unrequired waste ink is carried out through use of a pump 65. In this embodiment, description has been given of an example of a sucking operation in which the pump provided on a downstream side of the recording head is used, but the waste ink not used for recording may be discharged from the ejection orifice by a pressurizing operation using a pump provided on an upstream side of the recording head.

For example, when it becomes difficult to normally eject an ink because the ink dries and sticks in a flow path or the like communicating with the ejection orifice, the sucking operation is carried out to cause a new ink to flow from the ink storage portion 37. Thus, the state in which the normal ejection is difficult can be solved. Normally, when the plurality of ejection orifice arrays is arrayed in the same recording element substrate, the sucking operation is carried out with the same cap. For example, when the ejection orifice arrays for respectively ejecting a cyan ink, a magenta ink and a yellow ink are arrayed in the same recording element substrate, those inks are collectively sucked with the same cap. In general, when an ink for which sticking can be easily solved and an ink for which sticking cannot be easily solved are mixed, although the sticking of the ejection orifice for ejecting the ink for which sticking can be easily solved is solved, the sucking operation for the ink for which sticking cannot be easily solved needs to be continued, and thus the sticking recovery property is reduced.

### (Aqueous Ink)

In the ink jet recording method of the present invention, an ink containing a pigment is used. The method includes a step of recording an image by applying the ink ejected from an ejection orifice to a recording medium. Examples of the ink include a cyan ink, a magenta ink and a yellow ink. Now, components for forming the ink and the like are described. When there is no need to distinguish the cyan ink, the magenta ink and the yellow ink from each other, the inks are collectively referred to as “ink.” The inks of the respective colors may have the same configuration or have different configurations within a range of the preferable mode described below.

### [Coloring Material]

As a coloring material of the ink, a pigment is used from the viewpoint of improving the permanence of the image. In the three or more storage parts arrayed in one predetermined direction, a specific gravity of a pigment in an ink stored in the storage part arranged on the inner side needs to be larger than a specific gravity of a pigment in an ink stored in each of the storage parts arranged at both the end portions.

From the viewpoint of color developability and the like, a phthalocyanine pigment is preferably used in the cyan ink, a quinacridone pigment is preferably used in the magenta ink, and an azo pigment is preferably used in the yellow ink. The specific gravity of the pigment is preferably 1.0 or more to 2.0 or less, more preferably 1.2 or more to 2.0 or less. In the following, the numerical value in the parentheses of the pigment indicates the absolute specific gravity of the pigment. Examples of the pigment to be used as the cyan ink may include C.I. Pigment Blue 15:3 (1.6) and C.I. Pigment Blue 15:4 (1.7). Examples of the pigment to be used as the magenta ink may include quinacridone pigments, such as C.I. Pigment Red 122 (1.4), C.I. Pigment Red 202 (1.5) and C.I. Pigment Violet 19 (1.5). In the magenta ink, a diketopyrrolopyrrole pigment such as C.I. Pigment Red 254 (1.6), an azo pigment such as C.I. Pigment Red 150 (1.5), a dioxazine pigment such as C.I. Pigment Violet 23 (1.5) and a perylene pigment such as C.I. Pigment Red 149 (1.4) may also be used in combination with the quinacridone pigment for, for example, adjustment of the hue. Examples of the pigment to be used as the yellow ink may include C.I. Pigment Yellow 74 (1.4), C.I. Pigment Yellow 128 (1.5) and C.I. Pigment Yellow 155 (1.4).

The specific gravity of the pigment is a value (absolute specific gravity) measured for the pigment in conformity to JIS Z8807:2012, “Methods of measuring density and specific gravity of solid.” The specific gravity may be measured for a pigment taken out as appropriate from a pigment dispersion liquid or an ink, or may be measured through use of the pigment dispersion liquid or the ink. The specific gravity of the pigment particle in the ink can be measured through use of a density/specific gravity meter (e.g., product name “Portable Density/Specific Gravity Meter DA-130N” (manufactured by Kyoto Electronics Manufacturing Co., Ltd.) or the like). When the specific gravity of the pigment particle is measured through use of the pigment dispersion liquid or the ink, it is preferable to concentrate the pigment dispersion liquid or the ink or dilute the pigment dispersion liquid or the ink with water to use, as a measurement sample, a liquid obtained by adjusting the content (% by mass) of the pigment particle in the liquid to fall within a range of 1.0% by mass or more to 10.0% by mass or less with respect to the total mass of the liquid. Further, values described in “Organic Pigments Handbook” (written by Isao Hashimoto, Color Office, 2006) may also be used.

The content (% by mass) of the pigment in the ink is preferably 0.50% by mass or more to 10.00% by mass or less, more preferably 1.00% by mass or more to 8.00% by mass or less with respect to the total mass of the ink.

In the three or more storage parts arranged in one predetermined direction, the content of the pigment in the ink stored in the storage part arranged on the inner side is preferably smaller than the content of the pigment in the ink stored in each of the storage parts arranged at both the end portions. When the sucking operation is carried out in order to solve the sticking of the ink, an ink having a lower viscosity is more efficiently sucked. Further, in the sucking operation, normally, the plurality of ejection orifices corresponding to the respective inks is collectively sucked. When the ink for which sticking is solved and the ink for which sticking is not solved are both present, a negative pressure applied to the ink for which sticking is not solved is relatively reduced. As a result, the degree of reduction of the sticking of the ink for which sticking is not solved is liable to be reduced. In this case, the content of the pigment in the ink stored in the storage part arranged on the inner side, which tends to cause sticking, is relatively reduced. Thus, the difference in the sticking recovery property between the inks can be reduced, and the sticking recovery property can be further improved.

Examples of a dispersion system for the pigment may include a resin-dispersed pigment using a resin (resin dispersant) as a dispersant and a self-dispersible pigment having a hydrophilic group bonded to its particle surface. In addition, a resin-bonded pigment having a resin-containing organic group chemically bonded to its particle surface, a microcapsule pigment whose particle surface is covered with, for example, a resin, or the like may be used. Of those, it is particularly preferable to use a resin-dispersed pigment using a resin dispersant having a hydrophobic portion and a hydrophilic portion so that the hydrophobic portion of the resin dispersant is adsorbed to the particle surface of the pigment and the pigment is dispersed by the hydrophilic portion.

A resin that can disperse the pigment in an aqueous medium through the action of an anionic group is preferably used as a resin dispersant. A water-soluble resin to be described later may be used as the resin dispersant. When the resin-dispersed pigment is used, the mass ratio of the content (% by mass) of the pigment in the ink to the content (% by mass) of the resin dispersant therein is preferably 0.3 times or more to 10.0 times or less.

A pigment having an anionic group, such as a carboxylic acid group, a sulfonic acid group or a phosphonic acid group, bonded to its particle surface directly or through any other atomic group (—R—) may be used as the self-dispersible pigment. The anionic group may be any one of an acid type or a salt type. When the group is a salt type, the group may be in any one of a state in which part of the group dissociates or a state in which the entirety thereof dissociates. When the anionic group is a salt type, examples of a cation serving as a counterion may include an alkali metal cation, ammonium and an organic ammonium. Specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, groups obtained by combining those groups may be adopted.

An average particle diameter D50 (nm) of the pigment in the ink is preferably 80 nm or more to 200 nm or less, more preferably 100 nm or more to 150 nm or less. The “average particle diameter” herein means “cumulative 50% particle diameter (D50) in a volume base.” The cumulative 50% particle diameter (D50) in a volume base of the pigment can be measured through use of a particle size distribution-measuring apparatus based on a dynamic light scattering method (e.g., product name “UPA-EX150,” manufactured by Nikkiso Co., Ltd.). The measurement conditions can be as follows: for example, SetZero of 30 seconds; the number of times of measurement of three times; and the measurement time of 180 seconds.

In the three or more storage parts arranged in one predetermined direction, the average particle diameter of the pigment in the ink stored in the storage part arranged on the inner side is preferably smaller than the average particle diameter of the pigment in the ink stored in each of the storage parts arranged at both the end portions. When the average particle diameter of the pigment in the ink stored in the storage part arranged on the inner side, which tends to cause sticking, is relatively reduced, the difference in the sticking recovery property between the inks can be reduced, and the sticking recovery property can be further improved.

### [Resin]

A resin such as water-soluble resin may be incorporated into the ink. The content (% by mass) of the resin in the ink is preferably 0.10% by mass or more to 20.00% by mass or less, more preferably 0.50% by mass or more to 15.00% by mass or less with respect to the total mass of the ink. The resin may be added to the ink (i) for stabilizing the dispersed state of the pigment, that is, as a resin dispersant or an aid therefor. In addition, the resin may be added to the ink (ii) for improving the various characteristics of an image to be recorded. Examples of the form of the resin may include a block copolymer, a random copolymer, a graft copolymer and a combination thereof. The resin may be a water-soluble resin that can be dissolved in an aqueous medium or may be a resin particle to be dispersed in the aqueous medium.

Examples of the resin may include an acrylic resin, a urethane resin and an olefin resin. Of those, an acrylic resin and a urethane resin are preferred, and an acrylic resin is more preferred. The acrylic resin preferably has, as constituent units, a hydrophilic unit as a hydrophilic part and a hydrophobic unit as a hydrophobic part. The hydrophilic unit is a unit having a hydrophilic group such as an anionic group. The hydrophilic unit may be formed by, for example, polymerizing a hydrophilic monomer having a hydrophilic group. Examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrides and salts of these acidic monomers. A cation for forming the salt of the acidic monomer may be, for example, a lithium, sodium, potassium, ammonium or organic ammonium ion. The hydrophobic unit is a unit free of a hydrophilic group such as an anionic group. The hydrophobic unit may be formed by, for example, polymerizing the hydrophobic monomer free of a hydrophilic group such as anionic group. Examples of the hydrophobic monomer may include: monomers each having an aromatic ring, such as styrene, α-methylstyrene and benzyl (meth)acrylate; and (meth)acrylic acid ester-based monomers, such as methyl (meth)acrylate, butyl (meth)acrylate and 2-ethylhexyl (meth)acrylate.

Of those, an acrylic resin including a hydrophilic unit derived from (meth)acrylic acid and a hydrophobic unit derived from at least one kind selected from the group consisting of a monomer having an aromatic ring and a (meth)acrylic acid ester-based monomer is preferred. In particular, an acrylic resin including a hydrophilic unit derived from (meth)acrylic acid and a hydrophobic unit derived from at least one of a styrene monomer or an α-methylstyrene monomer is preferred. Those acrylic resins can each be suitably used as a resin dispersant for dispersing the pigment because the resins each easily interact with the pigment.

The urethane resin may be obtained by, for example, causing a polyisocyanate and a polyol to react with each other. In addition, a chain extender may be further caused to react with the reaction product. Examples of the olefin resin may include polyethylene and polypropylene.

The phrase “resin is water-soluble” as used herein means that when the resin is neutralized with an alkali in an amount equivalent to its acid value, the resin is present in an aqueous medium under a state in which the resin does not form any particle whose particle diameter may be measured by a dynamic light scattering method. Whether or not a resin is water-soluble may be determined in accordance with a method described below. First, a liquid (resin solid content: 10% by mass) containing a resin neutralized with an alkali (e.g., sodium hydroxide or potassium hydroxide) equivalent to its acid value is prepared. Next, the prepared liquid is diluted 10-fold (based on a volume) with pure water to prepare a sample solution. Then, when the particle diameter of the resin in the sample solution is measured by a dynamic light scattering method, and a particle having a particle diameter is not measured, the resin may be determined to be water-soluble. Meanwhile, when a particle having a particle diameter is measured, the resin may be determined as “resin particle” (that is, “water dispersible resin”). Measurement conditions in this case may be set, for example, as described below.

### [Measurement Conditions]

Set Zero: 30 seconds
Number of times of measurement: three times
Measurement time: 180 seconds

A particle size analyzer based on a dynamic light scattering method (e.g., product name “UPA-EX150”, manufactured by Nikkiso Co., Ltd.) or the like may be used as a particle size distribution-measuring apparatus. The particle size distribution-measuring apparatus to be used, the measurement conditions and the like are of course not limited to the foregoing.

### [Aqueous Medium]

The ink is an aqueous ink containing an aqueous medium that is a mixed solvent of water and a water-soluble organic solvent. Deionized water (ion-exchanged water) is preferably used as the water. The content (% by mass) of the water in the ink is preferably 50.00% by mass or more to 95.00% by mass or less with respect to the total mass of the ink.

Solvents that may be used in inks for ink jet, such as alcohols, glycols, (poly)alkylene glycols, nitrogen-containing compounds and sulfur-containing compounds, may each be used as the water-soluble organic solvent. The content (% by mass) of the water-soluble organic solvent in the ink is preferably 3.00% by mass or more to 50.00% by mass or less with respect to the total mass of the ink. Although the “water-soluble organic solvent” is typically a liquid, in the present invention, a solvent that is a solid at 25° C. (normal temperature) is also included in the category of the water-soluble organic solvent for convenience. Examples of the water-soluble organic solvent that is generally used in the aqueous ink and is a solid at 25° C. may include 1,6-hexanediol, trimethylolpropane, ethylene urea, urea, polyethylene glycol having a number-average molecular weight of 1,000 and saccharides.

In the three or more storage parts arrayed in one predetermined direction, the content of the water-soluble organic solvent in the ink stored in the storage part arranged on the inner side is preferably larger than the content of the water-soluble organic solvent in the ink stored in each of the storage parts arranged at both the end portions. When the storage parts storing two inks having different contents of the water-soluble organic solvents are arranged adjacent to each other, water moves from the ink having a larger content of the water-soluble organic solvent to the ink having a smaller content of the water-soluble organic solvent. When the content of the water-soluble organic solvent in the ink stored in the storage part arranged on the inner side is set to be relatively larger, water moves from each of the storage parts arranged at both the end portions to the storage part arranged on the inner side, and thus the sticking recovery property can be further improved.

### [Surfactant]

The ink preferably further contains a surfactant. Examples of the surfactant may include an anionic surfactant, a cationic surfactant, a nonionic surfactant, an amphoteric surfactant and other surfactants. Of those, a nonionic surfactant is preferably used.

Examples of the anionic surfactant may include a polyoxyethylene alkylether sulfuric acid ester salt, a polyoxyethylene alkylether sulfonic acid salt, a polyoxyethylene alkyl phenyl ether sulfuric acid ester salt, a polyoxyethylene alkyl phenyl ether sulfonic acid salt, an alpha-sulfo fatty acid ester salt, an alkylbenzene sulfonic acid salt, an alkylphenol sulfonic acid salt, an alkylnaphthalene sulfonic acid salt, an alkyltetralin sulfonic acid salt and a dialkyl sulfosuccinic acid salt. Examples of the cationic surfactant may include an alkyltrimethylammonium salt and a dialkyldimethylammonium chloride.

Examples of the nonionic surfactant include an acetylene glycol-based surfactant, a polyoxyethylene alkylether, a polyoxyethylene fatty acid ester, a polyoxyethylene alkyl phenyl ether, a fatty acid diethanol amide and a polyoxyethylene-polyoxypropylene block copolymer. An example of the amphoteric surfactant is an alkyl carboxybetaine. Examples of the other surfactant may include a fluorine-based surfactant and a silicone-based surfactant.

The content (% by mass) of the surfactant in the ink is preferably 0.10% by mass or more to 5.00% by mass or less, more preferably 0.10% by mass or more to 2.00% by mass or less with respect to the total mass of the ink.

### [Other Components]

Besides the above-mentioned components, as required, the ink may also contain various additives, such as an antifoam agent, a pH adjuster, a viscosity adjuster, a rust preventive, a preservative, a fungicide, an antioxidant and a reduction inhibitor.

### [Physical Properties of Ink]

The ink is an aqueous ink to be applied to an ink jet system. Accordingly, from the viewpoint of reliability, it is preferred that the physical property values of the ink be appropriately controlled. Specifically, the static surface tension of the ink at 25° C. is preferably 28 mN/m or more to 45 mN/m or less. In addition, the viscosity of the ink at 25° C. is preferably 1.0 mPa·s or more to 5.0 mPa·s or less, more preferably 1.0 mPa·s or more to 3.0 mPa·s or less. The pH of the ink at 25° C. is preferably 5.0 or more to 9.5 or less.

In the three or more storage parts arranged in one predetermined direction, the viscosity of the ink stored in the storage part arranged on the inner side is preferably lower than the viscosity of the ink stored in each of the storage parts arranged at both the end portions. When the sucking operation is carried out in order to solve the sticking of the ink, an ink having a lower viscosity is more efficiently sucked. Further, in the sucking operation, normally, the plurality of ejection orifices corresponding to the respective inks is collectively sucked. When the ink for which sticking is solved and the ink for which sticking is not solved are both present, a negative pressure applied to the ink for which sticking is not solved is relatively reduced. As a result, in some cases, the sticking of the ink for which sticking is not solved may be less likely to be reduced. In this case, the viscosity of the ink stored in the storage part arranged on the inner side, which tends to cause sticking, is made relatively lower. Thus, the difference in the sticking recovery property between the inks can be reduced, and the sticking recovery property can be further improved. The viscosity of the ink may be measured by a rotary viscometer.

### Examples

The present invention is described in more detail below by way of Examples and Comparative Examples. The present invention is by no means limited to Examples below without departing from the gist of the present invention. “Part(s)” and “%” with regard to the description of the amounts of components are by mass unless otherwise stated.

### <Preparation of Pigment Dispersion Liquid>

The average particle diameter of the pigment (cumulative 50% particle diameter in a volume base, D50) was measured through use of a particle size analyzer based on a dynamic light scattering method (product name “UPA-EX150,” manufactured by Nikkiso Co., Ltd.) under the following conditions: SetZero of 30 seconds; the number of times of measurement of three times; and the measurement time of 180 seconds.

### (Pigment Dispersion Liquid 1)

A water-soluble resin was neutralized with potassium hydroxide in an equimolar amount to its acid value and was dissolved in ion-exchanged water to prepare an aqueous solution of a resin dispersant having a resin content (solid content) of 20.00%. As the water-soluble resin, a styrene-acrylic acid copolymer (composition (molar) ratio=33:67, weight-average molecular weight: 10,000, acid value: 200 mgKOH/g) was used. A mixture of 15.0 parts of C.I. Pigment Blue 15:3, 22.5 parts of the aqueous solution of the resin dispersant and 62.5 parts of water was put in a sand grinder and subjected to dispersion treatment for 1 hour. Then, a coarse particle was removed by centrifugation treatment. The specific gravity of C.I. Pigment Blue 15:3 is 1.6 g/cm³. The supernatant was filtered with a microfilter having a pore size of 3.0 μm (manufactured by FUJIFILM Corporation) under pressure, and an appropriate amount of ion-exchanged water was added to provide a pigment dispersion liquid 1. The content of the pigment in the pigment dispersion liquid 1 was 10.00%, the content of the resin dispersant therein was 3.00%, and the average particle diameter D50 of the pigment was 120 nm.

### (Pigment Dispersion Liquid 2)

A pigment dispersion liquid 2 was obtained similarly to the pigment dispersion liquid 1 described above except that the dispersion treatment time was changed from 1 hour to 45 minutes. The content of the pigment in the pigment dispersion liquid 2 was 10.00%, the content of the resin dispersant therein was 3.00%, and the average particle diameter D50 of the pigment was 129 nm.

### (Pigment Dispersion Liquid 3)

A pigment dispersion liquid 3 was obtained similarly to the pigment dispersion liquid 1 described above except that the dispersion treatment time was changed from 1 hour to 30 minutes. The content of the pigment in the pigment dispersion liquid 3 was 10.00%, the content of the resin dispersant therein was 3.00%, and the average particle diameter D50 of the pigment was 135 nm.

### (Pigment Dispersion Liquid 4)

A pigment dispersion liquid 4 was obtained similarly to the pigment dispersion liquid 1 described above except that C.I. Pigment Violet 19 was used in place of C.I. Pigment Blue 15:3. The specific gravity of the C.I. Pigment Violet 19 is 1.5 g/cm³. The content of the pigment in the pigment dispersion liquid 4 was 10.00%, the content of the resin dispersant therein was 3.00%, and the average particle diameter D50 of the pigment was 130 nm.

### (Pigment Dispersion Liquid 5)

A pigment dispersion liquid 5 was obtained similarly to the pigment dispersion liquid 1 described above except that C.I. Pigment Red 150 was used in place of C.I. Pigment Blue 15:3. The specific gravity of the C.I. Pigment Red 150 is 1.5 g/cm³. The content of the pigment in the pigment dispersion liquid 5 was 10.00%, the content of the resin dispersant therein was 3.00%, and the average particle diameter D50 of the pigment was 130 nm.

### (Pigment Dispersion Liquid 6)

A pigment dispersion liquid 6 was obtained similarly to the pigment dispersion liquid 1 described above except that C.I. Pigment Red 122 was used in place of C.I. Pigment Blue 15:3. The specific gravity of the C.I. Pigment Red 122 is 1.4 g/cm³. The content of the pigment in the pigment dispersion liquid 6 was 10.00%, the content of the resin dispersant therein was 3.00%, and the average particle diameter D50 of the pigment was 130 nm.

### (Pigment Dispersion Liquid 7)

A pigment dispersion liquid 7 was obtained similarly to the pigment dispersion liquid 1 described above except that C.I. Pigment Yellow 74 was used in place of C.I. Pigment Blue 15:3. The specific gravity of the C.I. Pigment Yellow 74 is 1.4 g/cm³. The content of the pigment in the pigment dispersion liquid 7 was 10.00%, the content of the resin dispersant therein was 3.00%, and the average particle diameter D50 of the pigment was 130 nm.

### (Pigment Dispersion Liquid 8)

A pigment dispersion liquid 8 was obtained similarly to the pigment dispersion liquid 1 described above except that C.I. Pigment Yellow 155 was used in place of C.I. Pigment Blue 15:3. The specific gravity of the C.I. Pigment Yellow 155 is 1.5 g/cm³. The content of the pigment in the pigment dispersion liquid 8 was 10.00%, the content of the resin dispersant therein was 3.00%, and the average particle diameter D50 of the pigment was 130 nm.

### <Preparation of Liquid Containing Dye>

Each of dyes 1 to 3 described below was dissolved in ion-exchanged water to provide a liquid containing each of the dyes 1 to 3 (having a dye content of 10.00%).
Dye 1: C.I. Direct Blue 199
Dye 2: C.I. Acid Red 289
Dye 3: C.I. Direct Yellow 132

### <Preparation of Ink>

Components (unit: %) shown in the upper section of Table 1 (Table 1-1 and Table 1-2) were mixed and sufficiently stirred. After that, the mixtures were filtered with a polypropylene filter having a pore size of 2.5 μm (manufactured by Pall Corporation) under pressure to prepare respective inks. In Table 1, the value for polyethylene glycol is number average molecular weight. Acetylenol E100 is a trade name for an acetylene glycol-based nonionic surfactant (manufactured by Kawaken Fine Chemical). The lower section of Table 1 show physical properties of the prepared inks. The viscosity of each of the inks was measured under the temperature condition of 25° C. through use of a rotary viscometer (product name “RE80 type viscometer,” manufactured by Toki Sangyo Co., Ltd.). The average particle diameter of the pigment in each ink was equivalent to the value measured for the pigment in the pigment dispersion liquid.

TABLE 1-1
Composition and characteristics of ink

| | Ink | | | | | | | |
|---|---|---|---|---|---|---|---|---|
| | C1 | C2 | C3 | C4 | C5 | C6 | C7 | C8 |
| Pigment dispersion | 30.00 | 30.00 | 30.00 | 39.00 | 40.00 | | | 30.00 |
| liquid 1 | | | | | | | | |
| Pigment dispersion | | | | | | 30.00 | | |
| liquid 2 | | | | | | | | |
| Pigment dispersion | | | | | | | 30.00 | |
| liquid 3 | | | | | | | | |
| Pigment dispersion | | | | | | | | |
| liquid 4 | | | | | | | | |
| Pigment dispersion | | | | | | | | |
| liquid 5 | | | | | | | | |
| Pigment dispersion | | | | | | | | |
| liquid 6 | | | | | | | | |
| Pigment dispersion | | | | | | | | |
| liquid 7 | | | | | | | | |
| Pigment dispersion | | | | | | | | |
| liquid 8 | | | | | | | | |
| Liquid containing dye | | | | | | | | |
| 1 | | | | | | | | |
| Liquid containing dye | | | | | | | | |
| 2 | | | | | | | | |
| Liquid containing dye | | | | | | | | |
| 3 | | | | | | | | |
| Glycerin | 18.00 | 18.00 | 14.00 | 18.00 | 18.00 | 18.00 | 18.00 | 18.00 |
| Triethylene glycol | 5.00 | 2.80 | 5.00 | 5.50 | 5.60 | 5.00 | 5.00 | 4.60 |
| 1,6-Hexanediol | 3.00 | 3.00 | 3.00 | 3.00 | 3.00 | 3.00 | 3.00 | 3.00 |
| Polyethylene glycol | 1.00 | 1.20 | 2.00 | 0.50 | 0.40 | 1.00 | 1.00 | 1.40 |
| 2000 | | | | | | | | |
| ACETYLENOL | 0.50 | 0.50 | 0.50 | 0.50 | 0.50 | 0.50 | 0.50 | 0.50 |
| E100 | | | | | | | | |
| Pure water | 42.50 | 44.50 | 45.50 | 33.50 | 32.50 | 42.50 | 42.50 | 42.50 |
| Content (%) of | 3.00 | 3.00 | 3.00 | 3.90 | 4.00 | 3.00 | 3.00 | 3.00 |
| pigment | | | | | | | | |
| Content (%) of water- | 27.00 | 25.00 | 24.00 | 27.00 | 27.00 | 27.00 | 27.00 | 27.00 |
| soluble organic | | | | | | | | |
| solvent | | | | | | | | |
| Viscosity (mPa · s) | 3.0 | 3.0 | 3.0 | 3.0 | 3.0 | 3.0 | 3.0 | 3.4 |

TABLE 1-2
Composition and characteristics of ink

| | Ink | | | | | | | | |
|---|---|---|---|---|---|---|---|---|---|
| | C9 | C10 | M1 | M2 | M3 | M4 | Y1 | Y2 | Y3 |
| Pigment dispersion | 30.00 | | | | | | | | |
| liquid 1 | | | | | | | | | |
| Pigment dispersion | | | | | | | | | |
| liquid 2 | | | | | | | | | |
| Pigment dispersion | | | | | | | | | |
| liquid 3 | | | | | | | | | |
| Pigment dispersion | | | 40.00 | | | | | | |
| liquid 4 | | | | | | | | | |
| Pigment dispersion | | | | 40.00 | | | | | |
| liquid 5 | | | | | | | | | |
| Pigment dispersion | | | | | 40.00 | | | | |
| liquid 6 | | | | | | | | | |
| Pigment dispersion | | | | | | | 40.00 | | |
| liquid 7 | | | | | | | | | |
| Pigment dispersion | | | | | | | | 40.00 | |
| liquid 8 | | | | | | | | | |
| Liquid containing | | 30.00 | | | | | | | |
| dye 1 | | | | | | | | | |
| Liquid containing | | | | | | 30.00 | | | |
| dye 2 | | | | | | | | | |
| Liquid containing | | | | | | | | | 30.00 |
| dye 3 | | | | | | | | | |
| Glycerin | 18.00 | 18.00 | 14.00 | 14.00 | 14.00 | 18.00 | 14.00 | 14.00 | 18.00 |
| Triethylene glycol | 4.00 | 5.00 | 5.00 | 5.00 | 5.00 | 5.00 | 5.00 | 5.00 | 5.00 |
| 1,6-Hexanediol | 3.00 | 3.00 | 3.00 | 3.00 | 3.00 | 3.00 | 3.00 | 3.00 | 3.00 |
| Polyethylene glycol | 2.00 | 1.00 | 2.00 | 2.00 | 2.00 | 1.00 | 2.00 | 2.00 | 1.00 |
| 2000 | | | | | | | | | |
| ACETYLENOL | 0.50 | 0.50 | 0.50 | 0.50 | 0.50 | 0.50 | 0.50 | 0.50 | 0.50 |
| E100 | | | | | | | | | |
| Pure water | 42.50 | 42.50 | 35.50 | 35.50 | 35.50 | 42.50 | 35.50 | 35.50 | 42.50 |
| Content (%) of | 3.00 | 0.00 | 4.00 | 4.00 | 4.00 | 0.00 | 4.00 | 4.00 | 0.00 |
| pigment | | | | | | | | | |
| Content (%) of | 27.00 | 27.00 | 24.00 | 24.00 | 24.00 | 27.00 | 24.00 | 24.00 | 27.00 |
| water-soluble | | | | | | | | | |
| organic solvent | | | | | | | | | |
| Viscosity (mPa · s) | 4.0 | 2.0 | 3.5 | 3.5 | 3.5 | 2.0 | 3.5 | 3.5 | 2.0 |

### <Configuration of Recording Unit>

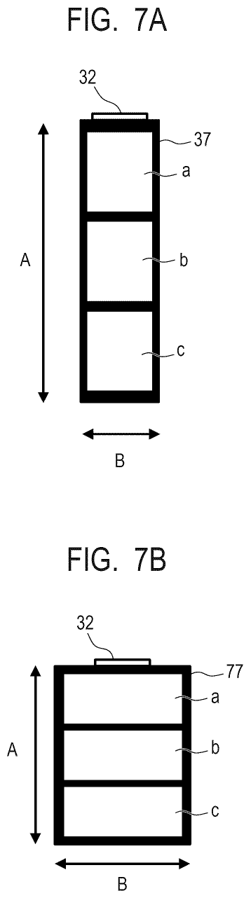

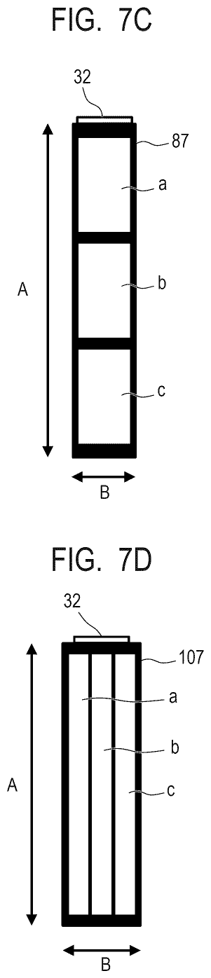

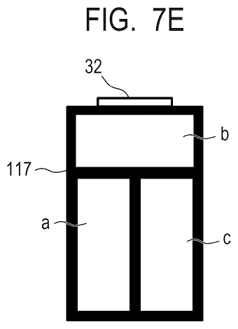

A recording head employing a system of ejecting an ink by applying thermal energy was prepared. In the recording element substrate forming the recording head, an ejection orifice array formed of 384 ejection orifices arrayed at an array density of 600 dpi is arranged. The mass of an ink droplet ejected from one ejection orifice is 5.5 ng. Further, a thermoplastic resin composition was molded to provide recording units 1 to 9 having ink storage portions arranged in the manner illustrated in FIG. 7A to FIG. 7E. As the thermoplastic resin composition, there was used a thermoplastic resin composition obtained by adding, as the filler material, 25 parts of E-glass chopped strand having a length of 5 mm to 100 parts of a thermoplastic resin being a mixture of a styrene-based resin and polyphenylene ether. The characteristics of the obtained recording units are shown in Table 2.

In the ink storage portion 37 illustrated in FIG. 7A, three storage parts “a” to “c” are arrayed in a direction orthogonal to a scanning direction of the recording head. In an ink storage portion 77 illustrated in FIG. 7B, three storage parts “a” to “c” are arrayed in a direction orthogonal to a scanning direction of the recording head. In an ink storage portion 87 illustrated in FIG. 7C, three storage parts “a” to “c” are arrayed in a direction orthogonal to a scanning direction of the recording head. In an ink storage portion 107 illustrated in FIG. 7D, three storage parts “a” to “c” are arrayed in a direction parallel to the scanning direction of the recording head. In an ink storage portion 117 illustrated in FIG. 7E, three storage parts “a” to “c” are arranged in a T-shape instead of being arranged in one direction. Ink storage portions 7 and 8 shown in Table 2 were obtained by molding a thermoplastic resin that is a mixture of a styrene-based resin and polyphenylene ether, that is, a thermoplastic resin having no filler material added thereto. The characteristics of the ink storage portions are shown in Table 2. In addition, the recording head is bonded to the obtained ink storage portion without intermediation of any other member to manufacture the recording unit.

TABLE 2
Characteristics of recording units

| Recording | Filler | | Ratio |
|---|---|---|---|
| unit | material | Shape | A/B |
| 1 | Present | FIG. 7A | 3.0 |
| 2 | Present | FIG. 7B | 1.5 |
| 3 | Present | FIG. 7B | 2.0 |
| 4 | Present | FIG. 7C | 4.0 |
| 5 | Present | FIG. 7C | 4.5 |
| 6 | Present | FIG. 7D | 3.0 |
| 7 | Absent | FIG. 7A | 3.0 |
| 8 | Absent | FIG. 7E | — |
| 9 | Present | FIG. 7E | — |

### <Evaluation>

### (Ink Jet Recording Apparatus)

A product name “PIXUS TS5130S” (manufactured by Canon Inc.) was prepared as an apparatus 1 as an ink jet recording apparatus of a type in which, when an ink stored inside of the ink storage portion (ink cartridge) has been consumed, the ink storage portion is replaced with a new ink storage portion filled with the ink. Further, a product name “G3370” (manufactured by Canon Inc.) was prepared as an apparatus 2 as an ink jet recording apparatus of a type in which an ink storage portion (sub tank) on a carriage and an ink storage portion (main tank) placed in the apparatus are connected to each other by a tube through which the ink flows. Those apparatus were modified to allow the prepared recording unit described above to be mounted thereon. In this Example, the recording duty of a solid image recorded under the following condition is defined as 100%: two ink droplets having a mass per droplet of 5.5 ng are applied to a unit region measuring 1/600 inch by 1/600 inch. In the present invention, in evaluation criteria for each of the following items, while levels “A” and “B” were defined as acceptable levels, a level “C” was defined as an unacceptable level. The evaluation results are shown in Table 3 (Table 3-1 and Table 3-2). In Table 3, symbols (“a” to “c”) indicating the positions of the inks of the respective colors correspond to symbols (“a” to “c”) in FIG. 7A to FIG. 7E.

### (Strength of Ink Storage Portion)

In order to promote deformation by the heat of the ink storage portion (casing), the recording unit was stored for 1 month under an environment at a temperature of 60° C. Under a state in which the upper surface of the ink storage portion was directed downward in the gravity direction and the ejection orifice surface of the recording head was directed upward, the recording unit was dropped twice on a lauan material from a height of 80 cm. The ink storage portion of the recording unit after dropping was visually observed, and the strength of the ink storage portion was evaluated in accordance with the evaluation criteria shown below.
A: No cracking or chipping of the ink storage portion occurred.
B: Cracking or chipping of the ink storage portion occurred, but no ink leakage was observed.
C: Cracking or chipping of the ink storage portion occurred, and ink leakage was observed.

### (Sticking Recovery Property)

An ink of a kind shown in Table 1 was stored in the ink storage portion, and the ink storage portion was mounted to the ink jet recording apparatus. The pump was used to supply the ink to the recording head, and a nozzle check pattern of the apparatus 1 or 2 was recorded. Then, after it was confirmed that the ink had been ejected from all of the ejection orifices (nozzles), the apparatus 1 or 2 was left for 3 months under an environment at a temperature of 35° C. and a relative humidity of 20%. After the leaving, the sucking operation was performed to measure the number of times required until the recovery from the sticking of the ink, and the sticking recovery property was evaluated in accordance with the evaluation criteria shown below.
A: The number of sucking operations required until the ink was ejected from all of the ejection orifices was 2 time or less.
B: The number of sucking operations required until the ink was ejected from all of the ejection orifices was 3 times.
C: The number of sucking operations required until the ink was ejected from all of the ejection orifices was 4 times or more.

### (Apparatus Size)

The apparatus 1 or 2 was modified so as to allow the recording unit to be mounted thereon. Then, the sizes of the apparatus before and after the modification were compared to evaluate the apparatus size in accordance with the evaluation criteria shown below.
A: Downsizing was achieved through modification.
B: An equivalent size was obtained through modification.
C: The size was increased through modification.

TABLE 3-1
Evaluation conditions

| | | Evaluation conditions | | | | |
|---|---|---|---|---|---|---|
| | | | Recording unit | | | |
| | | | | | Position | Position |
| | | | | Position | of | of |
| | | Kind of | | of | magenta | yellow |
| | | apparatus | Kind | cyan ink | ink | ink |
| Example | 1 | 1 | 1 | b | a | c |
| | 2 | 1 | 1 | b | a | c |
| | 3 | 1 | 1 | b | a | c |
| | 4 | 1 | 1 | b | a | c |
| | 5 | 1 | 1 | b | a | c |
| | 6 | 1 | 1 | b | a | c |
| | 7 | 1 | 1 | b | a | c |
| | 8 | 1 | 1 | b | a | c |
| | 9 | 1 | 1 | b | a | c |
| | 10 | 1 | 1 | b | a | c |
| | 11 | 1 | 1 | b | a | c |
| | 12 | 1 | 1 | b | a | c |
| | 13 | 1 | 1 | b | a | c |
| | 14 | 1 | 1 | b | a | c |
| | 15 | 1 | 2 | b | a | c |
| | 16 | 1 | 3 | b | a | c |
| | 17 | 1 | 4 | b | a | c |
| | 18 | 1 | 5 | b | a | c |
| | 19 | 1 | 6 | b | a | c |
| | 20 | 2 | 1 | b | a | c |
| Comparative | 1 | 1 | 7 | b | a | c |
| Example | 2 | 1 | 7 | a | b | c |
| | 3 | 1 | 8 | b | a | c |
| | 4 | 1 | 9 | a | b | c |
| | 5 | 1 | 9 | b | a | c |
| | 6 | 1 | 1 | a | b | c |
| | 7 | 1 | 2 | a | b | c |
| | 8 | 1 | 5 | a | b | c |
| | 9 | 1 | 6 | a | b | c |
| Reference | 1 | 1 | 8 | a | b | c |
| Example | 2 | 1 | 1 | a | b | c |
| | 3 | 1 | 1 | b | c | a |
| | 4 | 1 | 1 | c | a | b |

TABLE 3-2
Evaluation conditions and evaluation results

| | | Evaluation conditions | | | Evaluation results | | |
|---|---|---|---|---|---|---|---|
| | | Kind of ink | | | | Sticking | Appa- |
| | | Cyan | Magenta | Yellow | | recovery | ratus |
| | | Ink | Ink | Ink | Strength | property | size |
| Example | 1 | C1 | M1 | Y1 | A | A | A |
| | 2 | C1 | M2 | Y1 | A | A | A |
| | 3 | C1 | M3 | Y1 | A | A | A |
| | 4 | C1 | M1 | Y2 | A | A | A |
| | 5 | C1 | M2 | Y2 | A | A | A |
| | 6 | C1 | M3 | Y2 | A | A | A |
| | 7 | C2 | M1 | Y1 | A | A | A |
| | 8 | C3 | M1 | Y1 | A | B | A |
| | 9 | C4 | M1 | Y1 | A | A | A |
| | 10 | C5 | M1 | Y1 | A | B | A |
| | 11 | C6 | M1 | Y1 | A | A | A |
| | 12 | C7 | M1 | Y1 | A | B | A |
| | 13 | C8 | M1 | Y1 | A | A | A |
| | 14 | C9 | M1 | Y1 | A | B | A |
| | 15 | C1 | M1 | Y1 | A | A | B |
| | 16 | C1 | M1 | Y1 | A | A | A |
| | 17 | C1 | M1 | Y1 | A | A | A |
| | 18 | C1 | M1 | Y1 | B | A | A |
| | 19 | C1 | M1 | Y1 | B | A | A |
| | 20 | C1 | M1 | Y1 | A | A | A |
| Com- | 1 | C1 | M1 | Y1 | C | A | A |
| parative | 2 | C1 | M1 | Y1 | C | A | A |
| Example | 3 | C1 | M1 | Y1 | C | A | A |
| | 4 | C1 | M1 | Y1 | A | C | A |
| | 5 | C1 | M1 | Y1 | A | C | A |
| | 6 | C1 | M1 | Y1 | A | C | A |
| | 7 | C1 | M1 | Y1 | A | C | B |
| | 8 | C1 | M1 | Y1 | B | C | A |
| | 9 | C1 | M1 | Y1 | B | C | A |
| Reference | 1 | C10 | M4 | Y3 | A | A | A |
| Example | 2 | C10 | M4 | Y3 | A | A | A |
| | 3 | C10 | M4 | Y3 | A | A | A |
| | 4 | C10 | M4 | Y3 | A | A | A |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-128303, filed Aug. 7, 2023, and Japanese Patent Application No. 2024-117458, filed Jul. 23, 2024, which are hereby incorporated by reference herein in their entirety.

What is claimed is:

1. An ink jet recording method using an ink jet recording apparatus, the ink jet recording apparatus comprising:
an aqueous ink comprising a pigment;
an ink storage portion which is configured to store the aqueous ink, and is formed from a thermoplastic resin composition comprising a filler material; and
a recording head to be bonded to the ink storage portion, the recording head having formed therein an ejection orifice configured to eject the aqueous ink supplied from the ink storage portion,
the ink jet recording method comprising recording an image by applying the aqueous ink ejected from the ejection orifice to a recording medium,
wherein the ink storage portion comprises three or more storage parts divided independently of each other, and the three or more storage parts are arrayed in one predetermined direction, and
wherein a specific gravity of the pigment in the aqueous ink stored in a corresponding one of the three or more storage parts arranged on an inner side is larger than a specific gravity of the pigment in the aqueous ink stored in each of corresponding two of the three or more storage parts arranged at both end portions.

2. The ink jet recording method according to claim 1, wherein the aqueous ink further comprises a water-soluble organic solvent, and
a content of the water-soluble organic solvent in the aqueous ink stored in the corresponding one of the three or more storage parts arranged on the inner side is larger than a content of the water-soluble organic solvent in the aqueous ink stored in each of the corresponding two of the three or more storage parts arranged at both the end portions.

3. The ink jet recording method according to claim 1, wherein a content of the pigment in the aqueous ink stored in the corresponding one of the three or more storage parts arranged on the inner side is smaller than a content of the pigment in the aqueous ink stored in each of the corresponding two of the three or more storage parts arranged at both the end portions.

4. The ink jet recording method according to claim 1, wherein an average particle diameter of the pigment in the aqueous ink stored in the corresponding one of the three or more storage parts arranged on the inner side is smaller than an average particle diameter of the pigment in the aqueous ink stored in each of the corresponding two of the three or more storage parts arranged at both the end portions.

5. The ink jet recording method according to claim 1, wherein a viscosity of the aqueous ink stored in the corresponding one of the three or more storage parts arranged on the inner side is lower than a viscosity of the aqueous ink stored in each of the corresponding two of the three or more storage parts arranged at both the end portions.

6. The ink jet recording method according to claim 1, wherein the recording head has formed therein an ejection orifice array in which a plurality of the ejection orifices is arrayed in parallel to a longitudinal direction of the ink storage portion, and
the ink storage portion has a ratio (A/B) of a length A in the longitudinal direction to a length B in a transverse direction orthogonal to the longitudinal direction, the ratio (A/B) being 2.0 times or more to 4.0 times or less.

7. The ink jet recording method according to claim 1, wherein the ink storage portion is replaced with another ink storage portion after the aqueous ink stored therein has been consumed.

8. The ink jet recording method according to claim 1, wherein the ink jet recording apparatus further comprises:
a second ink storage portion having a capacity larger than a capacity of the ink storage portion; and
a tube through which the aqueous ink flows between the second ink storage portion and the ink storage portion.

9. An ink jet recording apparatus comprising:
an aqueous ink comprising a pigment;
an ink storage portion which is configured to store the aqueous ink, and is formed from a thermoplastic resin composition comprising a filler material; and
a recording head to be bonded to the ink storage portion, the recording head having formed therein an ejection orifice configured to eject the aqueous ink supplied from the ink storage portion,
wherein the ink storage portion comprises three or more storage parts divided independently of each other, and the three or more storage parts are arrayed in one predetermined direction, and
wherein a specific gravity of the pigment in the aqueous ink stored in a corresponding one of the three or more storage parts arranged on an inner side is larger than a specific gravity of the pigment in the aqueous ink stored in each of corresponding two of the three or more storage parts arranged at both end portions.
